(19) United States
(12) Patent Application Publication
(10) Pub. No.: US 2003/0175011 A1
(43) Pub. Date: Sep. 18, 2003

(54) Reproduction apparatus

(75) Inventors: Ken Nagai, Ibaraki-shi (JP); Satoshi Yabuta, Takatsuki-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/388,853

(22) Filed: Mar. 14, 2003

(30) Foreign Application Priority Data
Mar. 14, 2002 (JP) 2002-69650

(51) Int. Cl. H04N 5/76; G11B 27/00

(52) U.S. Cl. 386/52; 386/111

(57) ABSTRACT

A reproduction apparatus that enables seamless reproduction by which a user does not recognize the connecting point of scenes, when arbitrary scenes in an AV data stream are connected in an arbitrary order to be reproduced. According to this reproduction apparatus, in the seamless reproduction mode, the transfer of stream data into a decoder is performed by inserting a control stream following the termination of one scene (CELL#n) and then transferring the next scene (CELL#(n+1)). When a control stream is detected in the transferred stream data, and if the scene following the detected control stream (CELL#(n+1)) begins with a B picture, a decoder does not decode this B picture.

### BACKGROUND OF THE INVENTION

1. Field of the Invention

The present invention relates to an apparatus for reproducing an audiovisual (AV) data stream that is coded according to the MPEG standard and the like.

2. Related Background Art

As media capable of recording and reproducing digital data, digital versatile disc (DVD) media such as DVD-RAM, DVD-R, and DVD-ROM are available. Such DVD media are used widely as large-capacity media of recording AV data.

Explanations of Play List

One of the features of a DVD resides in that high-speed random accessing can be performed with respect to recorded data. Exploiting this feature, a stream recorded on the DVD can be reproduced in the order different from the recorded order by specifying a reproduction path by a user. The reproduction path specified by the user is represented by a list in which reproduction sections are arranged, where one reproduction section is a section including a continuous stream whose starting point and ending point are designated. The list describing this reproduction path is called Play List (hereinafter referred to as PL).

In the case of the PL, one reproduction section is defined as CELL. When reproducing the PL, reproduction sections are reproduced successively by reading out the starting position and the ending position of a stream described in the PL and by supplying it to a decoder to perform the decoding. Every time one reproduction section has been completed, a stream in the section indicated by the next CELL is supplied. By repeating this procedure, the reproduction in the same manner as in the edit operation can be carried out without changing the arrangement of the stream on the DVD. Unlike the case where the direct edit operation is carried out to a stream recorded on the DVD, this procedure allows the stream to be edited any number of times while keeping the original state of the stream.

However, the arrangement of the AV stream on the recording media is not optimized for the PL editing. For that reason, in the case of the actual PL reproduction, there is a problem of the reproduction of AV data being interrupted at a connecting point of the reproduction. For example, when two scenes that are not continuous on the original stream are connected on the PL, if the latter scene begins with a forward-referring type picture, this forward-referring type picture cannot be reproduced because of the absence of the preceding picture to be referred to by this forward-referring type picture, thus generating a noise image at the connecting point of these two scenes.

In addition, conventionally, every time the reproduction of CELL has been completed, a decoder is initialized after the halt of the supplying of the AV stream. Therefore, a time period for the initialization and a time period for resuming the supplying of the AV stream are required at the connecting point of the reproduction. During these time periods, the reproduced image freezes, so that seamless reproduction cannot be done.

### SUMMARY OF THE INVENTION

Therefore, with the foregoing in mind, it is an object of the present invention to provide a reproduction apparatus that enables seamless reproduction so as not to make a user aware of the connecting point of scenes, when arbitrary scenes in an AV data stream are connected in an arbitrary order to be reproduced.

To fulfill the above-stated object, a reproduction apparatus according to the present invention decodes a coded AV data stream and reproduces the decoded AV data stream. The reproduction apparatus includes: a control data insertion unit for, in seamless reproduction to connect reproduction sections specified in the AV data stream in an arbitrary order, inserting seamless reproduction control data between the reproduction sections to be connected; a control data detection unit for detecting the seamless reproduction control data in the AV data stream to be reproduced; and a decoding cancel unit that, when the control data detection unit detects seamless reproduction control data and if one or a plurality of consecutive forward-referring type pictures are present at a head of the reproduction section following the detected seamless reproduction control data, does not perform decoding of the forward-referring type pictures.

Note here that the reproduction apparatus according to the present invention may have a recording function. A picture mentioned in the present invention is a unit of coding/decoding of video data. A forward-referring type picture is a picture subjected to the coding among pictures by referring to other pictures and, when decoding, needs to refer to a decoding result of another preceding picture in the AV data stream. For instance, a B picture according to the MPEG corresponds to this forward-referring type picture.

With the above-described configuration, when desired scenes designated by a user as reproduction sections are connected and reproduced in an arbitrary order and when the control data detection unit detects the seamless reproduction control data inserted by the control data insertion unit in the AV data stream to be reproduced, if one or a plurality of forward-referring type pictures are present at the head of the reproduction section following this seamless reproduction control data, the decoding of the forward-referring type pictures is not conducted. Here, “not conducting the decoding” may be realized by not-inputting the corresponding pictures into a decoder for decoding, or may be realized by inputting the corresponding pictures into a decoder and then initializing the decoder before starting the decoding procedure.

This configuration can overcome the conventional problem of interruption in the reproduction of AV data caused by being incapable of reproducing the head picture of the reproduction section following the connecting point of the reproduction sections. Therefore, the reproduction apparatus that enables seamless reproduction so as not to make a user aware of the connecting point of scenes can be provided.

Preferably, the reproduction apparatus according to the invention further includes a reference insertion unit for, if one or a plurality of consecutive forward-referring type pictures are present at a head of a reproduction section, inserting a reference picture that is to be referred to by the forward-referring type pictures after the seamless reproduction control data that is inserted before the reproduction section by the control data insertion unit.

Note here that the unit of data inserted by the reference insertion unit is not limited to the reference picture. For instance, the multiplexing unit (reproduction fundamental unit) of audio data and video data in the AV data stream that includes the reference picture may be inserted by the reference insertion unit.

With this configuration, even when a forward-referring type picture is present at the head of the latter reproduction section of the connected reproduction sections, this forward-referring type picture can be decoded because the reference picture to be referred to by this forward-referring type picture is inserted to enable the reference. As a result, although the reproduction begins with the reference picture, this configuration can prevent the cancellation of decoding of the head of the scene desired by the user.

In addition, in the above-described configuration further including the reference insertion unit, it is preferable to further include a parallel decoding unit for decoding the reference picture in parallel with decoding of the preceding reproduction section. With this configuration, the seamless reproduction can begin with the head of the scene desired by a user at the connecting point of the reproduction sections.

Preferably, each of the above-described reproduction apparatuses further includes an audio mute procedure unit for performing an audio mute procedure during a time period between (a) a predetermined time period before a connecting point of the reproduction sections and (b) a reproduction starting time of the reproduction section following the connecting point. With this configuration, sounds are muted at the connecting point of the reproduction sections, which can provide a smooth change of the sounds at a change between scenes.

Alternatively, each of the above-described reproduction apparatuses further may include an audio fade-out unit for performing an audio fade-out procedure a predetermined time period before a connecting point of the reproduction sections; and an audio fade-in unit for performing an audio fade-in procedure at a reproduction starting time of the reproduction section following the connecting point. With this configuration, sounds are faded out/faded-in at the connecting point of the reproduction sections, which can provide a further smooth change of the sounds at a change between scenes.

Preferably, each of the above-described reproduction apparatuses further includes a reproduction starting point rounding unit for, if a time specified as a starting point of a reproduction section does not agree with a starting point of a reproduction fundamental unit, making a head of a reproduction fundamental unit following the reproduction fundamental unit including the point specified as the starting point of the reproduction section the reproduction starting point of the reproduction section. In this configuration, the reproduction fundamental unit is a unit of multiplexing audio data and video data in the AV data stream. This configuration can make reproduction sections other than that designated by a user invisible to the user.

Preferably, each of the above-described reproduction apparatuses further includes a reproduction ending point rounding unit for, if a point specified as an ending point of a reproduction section does not agree with an ending point of a reproduction fundamental unit, making a termination of a reproduction fundamental unit preceding the reproduction fundamental unit including the point specified as the ending point of the reproduction section the reproduction ending point of the reproduction section. In this configuration, the reproduction fundamental unit is a unit of multiplexing audio data and video data in the AV data stream. This configuration can make reproduction sections other than that designated by a user invisible to the user.

Preferably, each of the above-described reproduction apparatuses further includes an intrapicture-coded picture frame-advance reproduction unit for reproducing only a first intrapicture-coded picture in a reproduction fundamental unit, wherein the reproduction fundamental unit is a unit of multiplexing audio data and video data in the AV data stream. Note here that the intrapicture-coded picture is a picture subjected to the coding using information on its picture only without referring to other pictures, and for example, an I picture according to the MPEG corresponds to this picture. With this configuration, when a user attempts a frame-advance reproduction mode to specify the starting point of a reproduction section, a failure of the normal frame-advance reproduction can be prevented, which might occur in the case of a forward-referring type picture that cannot be decoded independently of other pictures.

Preferably, each of the above-described reproduction apparatuses further includes a terminal picture frame-advance reproduction unit for reproducing only a picture at a termination in a reproduction fundamental unit, wherein the reproduction fundamental unit is a unit of multiplexing audio data and video data in the AV data stream. With this configuration, only a terminal picture in the reproduction fundamental unit undergoes the frame-advance reproduction, which can make the ending point of the reproduction section designated by a user agree with the terminal picture in the reproduction fundamental unit. Thus, this configuration has an advantage of making reproduction sections other than that designated by a user invisible to the user.

In each of the above-described reproduction apparatuses, a coding standard for the AV data is preferably the MPEG. The MPEG is used as a compression method of AV data for recording the AV data on DVD media and the like. Therefore, a reproduction apparatus enabling the seamless reproduction of AV data recorded on the DVD media and the like can be provided. Note here that when the coding standard for the AV data is the MPEG, the forward-referring type picture is a B picture.

In addition, when a coding standard for the AV data is the MPEG, a Sequence End Code prescribed by the MPEG standard or a control stream that is not present in the MPEG stream can be used as the seamless reproduction control data inserted by the control data insertion unit. As the control stream in the latter case, for example, a stream having a specific stream ID and also containing dummy data can be used, but the control stream is not limited to such an example.

### BRIEF DESCRIPTION OF THE DRAWINGS

FIG. 1 shows a relationship between the order of coding and the order of display of I pictures, P pictures and B pictures.

FIG. 2 shows an internal configuration of the MPEG system stream.

FIG. 3 shows a decoder model (P-STD) of an MPEG system decoder.

FIG. 4 explains a multiplexing method of the MPEG system stream.

FIG. 5 explains a relationship between VOBUs and the MPEG stream.

FIG. 6 explains a physical configuration and a logical configuration of data recorded on a DVD-RAM.

FIG. 7 explains a relationship between VOBs and the MPEG stream.

FIG. 8 explains an internal configuration of the GOP.

FIG. 9 is a block diagram showing functions of a digital video recording apparatus.

FIG. 10 shows a portion that contributes to the reproduction, mainly focusing on the decoder unit of FIG. 9.

FIG. 11 shows a relationship among PGC, CELL, VOBU and management information M_VOBI.

FIG. 12 is a schematic representation of the management information concerning PG or PL.

FIG. 13 is a schematic representation of the management information M_VOBI of FIG. 11.

FIG. 14 shows a data configuration of V_PCK in the VOBU.

FIG. 15 shows a data configuration of A_PCK in the VOBU.

FIG. 16 is a timing chart of the operation in Embodiment 1.

FIG. 17 is a flowchart of the operation in Embodiment 1.

FIG. 18 shows an example of a control stream for performing the seamless reproduction.

FIG. 19 is a timing chart of the operation in Embodiment 2.

FIG. 20 is a timing chart of the operation in Embodiment 3.

FIG. 21 is a flowchart of Embodiment 4.

FIG. 22 is a flowchart of Embodiment 5.

FIG. 23 is a flowchart of Embodiment 5.

### DETAILED DESCRIPTION OF THE INVENTION

The following describes embodiments of the recording/reproduction apparatus according to the present invention, with reference to the drawings. In the following description, a digital video recording apparatus employing a DVD as a recording medium is explained as a specific example of the recording/reproduction apparatus of the present invention.

In the following embodiments, a DVD-RAM is a writable medium that will be explained as one example of DVD media. Note here that a recording medium of data to be reproduced is not limited to this example. Normally, video data recorded on the DVD-RAM is compressed according to a method developed by the Moving Picture Experts Group (MPEG), phase 2 (so-called MPEG-2). Also, “DVD Specifications for Rewritable/Re-recordable Discs (DVD video recording standard, hereinafter referred to as DVR standard) has been developed and issued as the specifications of management information used for recording AV data with respect to the DVD-RAM.

Explanations of MPEG

AV data recorded on DVD media is compressed using the international standard called MPEG (ISO/IEC13818).

Even DVD media with a large capacity, i.e., several gigabytes, cannot have a sufficient capacity to record not-compressed digital AV data. Then, a method for compressing AV data to be recorded becomes necessary. Currently, as a compression method of AV data, MPEG (ISO/IEC13818) is used widely. With the development of LSI technology in recent years, an MPEG codec (decompression/compression LSI) has been put into practical use. This enables a DVD recorder to conduct the MPEG decompression/compression.

In order to realize data compression with high efficiency, the MPEG mainly has the following two features:

As the first feature, the MPEG employs a compression method utilizing time correlation properties among pictures, in addition to a conventional compression method using spatial frequency properties. Note here that a picture refers to a frame when a unit of the coding has a frame structure, or a field when the unit has a field structure. According to the MPEG, the data compression is performed by classifying pictures into three types of pictures: I pictures (intrapicture-coded picture); P pictures (picture using an intrapicture-coded picture and a referential relationship with a past picture); and B pictures (picture using an intrapicture-coded picture and a referential relationship with past and future pictures).

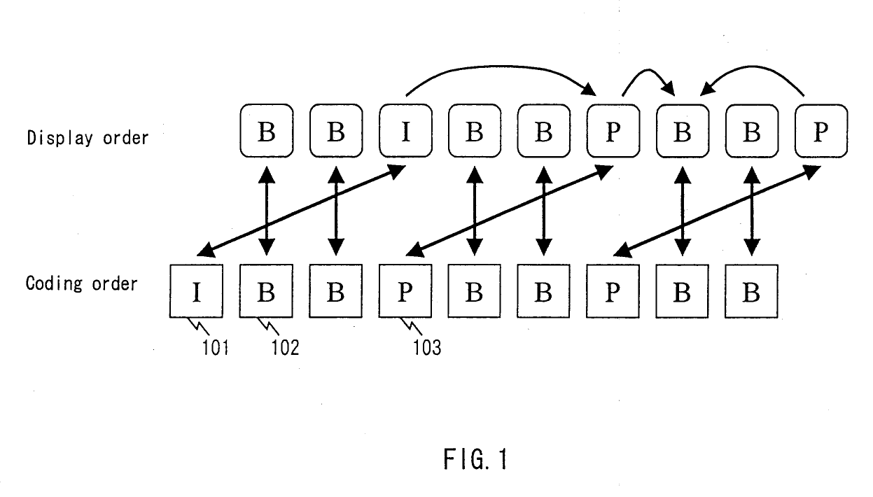

FIG. 1 shows a relationship between the order of coding and the order of display of I pictures, P pictures and B pictures. In FIG. 1, numerals 101, 102 and 103 denote I pictures, B pictures and P pictures, respectively. I pictures are subjected to the intrapicture-coding, and therefore I pictures can be reproduced without referring to other pictures when decoding. However, P pictures are subjected to coding among pictures by referring to a past I picture or P picture. For that reason, P pictures cannot be decoded unless the past I picture or P picture is decoded. B pictures are coded using bi-directional, i.e., both a past and a future I pictures or P pictures. For that reason, the decoding of B pictures requires the decoding of the past and the future I pictures or P pictures that are used for the prediction. As a result, a phenomenon, as shown in FIG. 1, occurs in which there is a discrepancy between the order of display and the order of coding of the respective pictures.

In addition, in order to realize particular reproduction modes such as a fast-forward mode, a fast-rewind mode and reproduction from a midpoint when reproducing from a DVD medium, the MPEG defines a configuration of Group of Pictures (GOP), in which compression/decompression is conducted in the unit of GOP. This configuration is required because, as described above, the video data coded according to the MPEG is generated based on the prediction among the past and future pictures and is not completed with a single picture. For that reason, the GOP is configured as a group of some pictures including at least one I picture to enable random accessing.

The second feature of the MPEG resides in that the amount of codes can be dynamically assigned in the unit of a picture depending on the complexity of an image. A decoder, according to the MPEG, is equipped with an input buffer (decoder buffer) for storing data in advance, which allows a large amount of codes to be assigned to a complicated image that is hard to be compressed.

Audio data used for DVD-RAMs can be selected from three types including: MPEG audio to conduct data compression; Dolby digital (AC-3); and not-compressed LPCM. Dolby digital and LPCM have a fixed bit rate. As for MPEG audio, several types of size can be selected in the unit of an audio frame, although the size is not as large as that of a video stream.

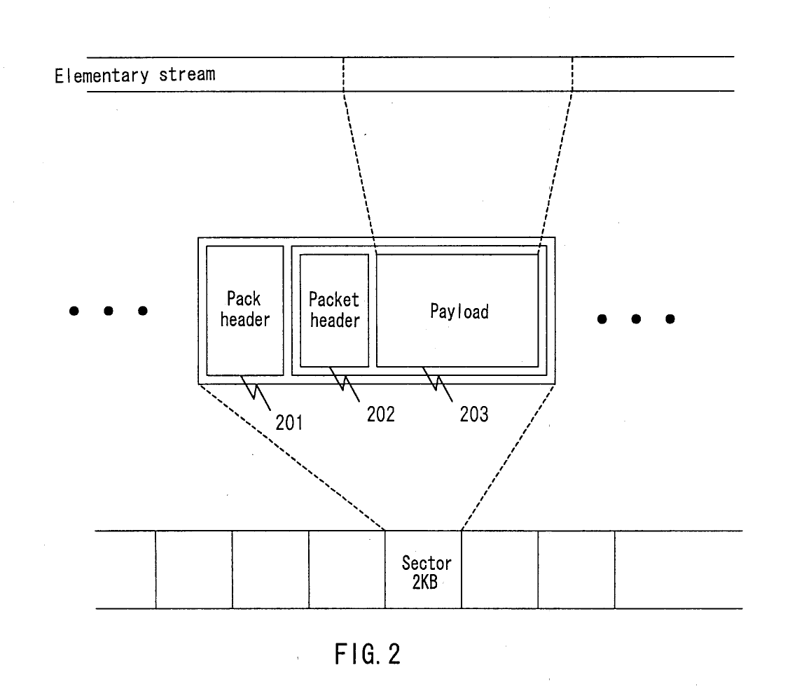

These AV data are multiplexed into one stream according to a method called the MPEG system. FIG. 2 shows an internal configuration of the MPEG system stream. In FIG. 2, numeral 201 denotes a pack header, 202 denotes a packet header, and 203 denotes a payload. The MPEG system stream has a hierarchical configuration called a pack and a packet. The packet is configured with the packet header 202 and the payload 203.

The AV data is partitioned into an adequate size from the beginning thereof, and then is stored in the payload 203. In the packet header 202, an ID (stream ID) for identifying the stored data, a Decoding Time Stamp (DTS) indicating a decoding time of the data stored in the payload, which is denoted with an accuracy of 90 kHz and a Presentation Time Stamp (PTS), are recorded as information on the AV data stored in the payload 203. Here, in the case where the decoding and the display are conducted simultaneously like audio data, the DTS will be omitted.

The pack is a unit of bringing a plurality of packets together. In the case of DVD-RAMs, one packet is used as one pack, and therefore the pack is configured with the pack header 201 and one packet (the packet header 202 and the payload 203). In the pack header, a time when data stored in this pack is input into the decoder buffer is recorded as System Clock Reference (SCR), which is denoted with an accuracy of 27 MHz.

In DVD-RAMs, such an MPEG system stream is recorded so that one pack corresponds to one sector (=2,048 bytes).

Decoding of the MPEG Stream

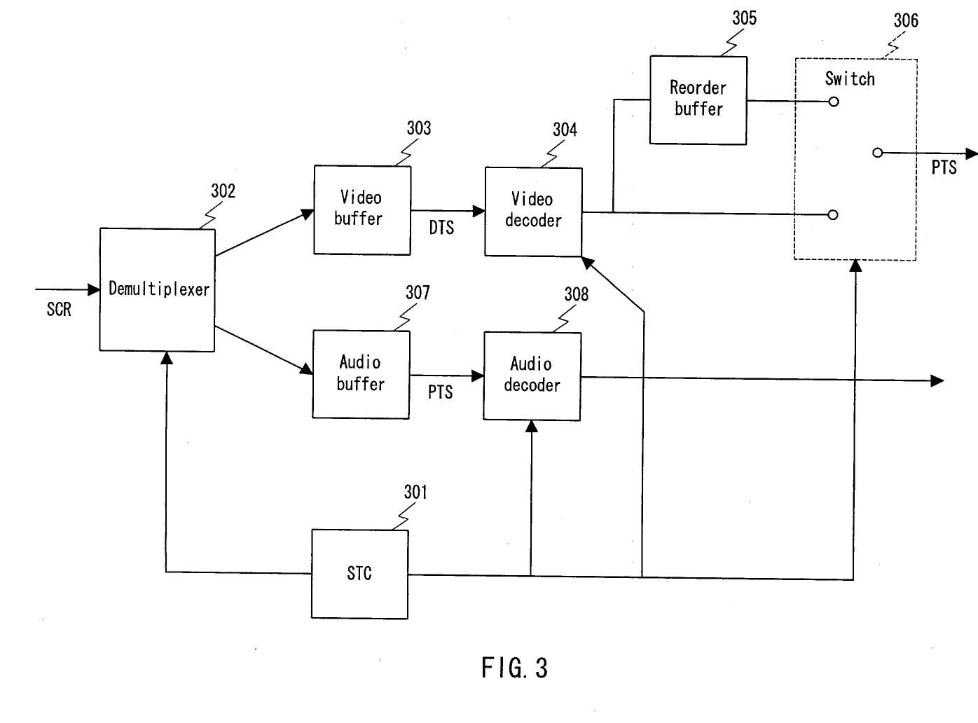

The following is the explanation of the decoding of the above-described MPEG system stream. FIG. 3 shows a decoder model (P-STD) of an MPEG system decoder. In FIG. 3, numeral 301 denotes System Time Clock (STC) serving as a standard time in the decoder, 302 denotes a demultiplexer for decoding the system stream, i.e., for resolving the multiplexing, 303 denotes an input buffer of a video decoder, 304 denotes the video decoder, 305 denotes a reorder buffer for temporarily storing I pictures and P pictures to absorb the above-described discrepancy between the order of decoding and the order of display generated among the I pictures, P pictures and B pictures, 306 denotes a selector for switching the order of outputting the I pictures, P pictures and B pictures stored in the reorder buffer, 307 denotes an input buffer of an audio decoder and 308 denotes the audio decoder.

Such an MPEG system decoder processes the above-described MPEG system stream as follows. When the time of STC 301 and the SCR described in the pack header agree with each other, the demultiplexer 302 inputs the corresponding pack. The demultiplexer 302 decodes the stream ID in the packet header and transmits the data in the payload to the decoder buffer for the respective streams (the video buffer 303 and the audio buffer 307). In addition, the demultiplexer 302 fetches the PDS and the DTS in the packet header.

At the time when the time of the STC 301 and the DTS agree with each other, the video decoder 304 fetches picture data from the video buffer 303 to decode the same. If the decoded picture is an I picture or a P picture, the picture is stored in the reorder buffer 305. If the picture is a B picture, the picture is displayed and is output as it is. If the picture being decoded by the video decoder 304 is an I picture or a P picture, the selector 306 connects a switch to the reorder buffer 305 side to output the I picture or the P picture stored in the reorder buffer 305. On the other hand, if the picture being decoded is a B picture, the selector 306 connects a switch to the video decoder 304 side.

As in the case of the video decoder 304, at the timing when the time of the STC 301 and the PTS (DTS is not present in the case of audio stream) agree with each other, the audio decoder 308 fetches data equivalent to one audio frame from the audio buffer 307 to decode the same.

Multiplexing of the MPEG System Stream

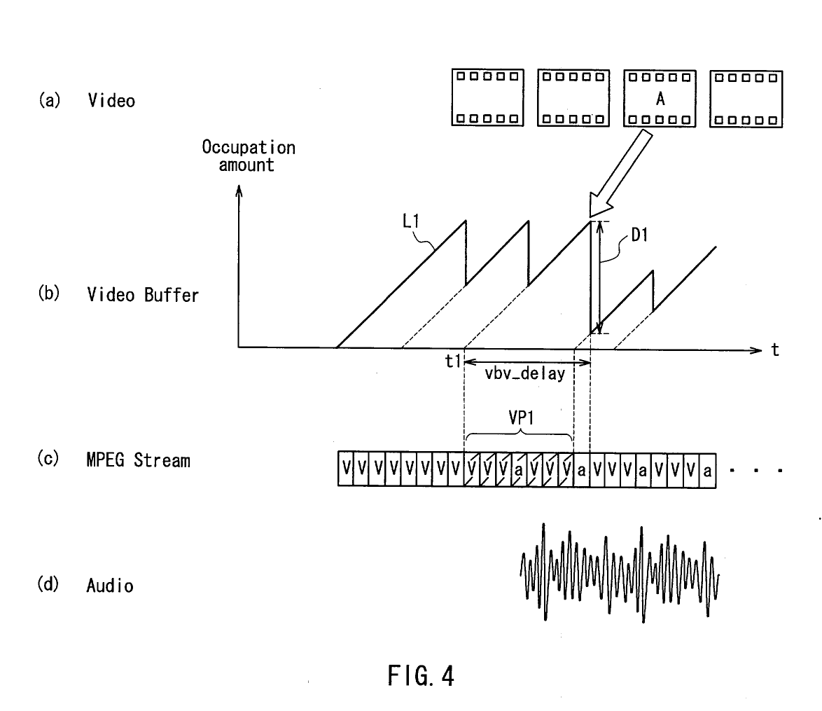

The following describes a method for multiplexing the MPEG system stream, with reference to FIG. 4. In FIG. 4, (a) illustrates a video frame, (b) illustrates a video buffer, (c) illustrates the MPEG system stream and (d) illustrates audio data. The horizontal axis represents a time axis shared with (a) through (d), so that (a) through (d) are illustrated on the same time axis. In the state of the video buffer illustrated in (b), the vertical axis represents a buffer occupation amount (the amount of data stored in the video buffer), and the bold line L1 in the graph represents a time transition of the buffer occupation amount. Therefore, in (b), the data amount indicated by a double-headed arrow along the vertical axis represents the data amount D1 transmitted from the buffer to the decoder at this time. The gradient of the bold line L1 corresponds to the bit rate of the video, which indicates that data is input into the buffer at a fixed rate. The decline in the buffer occupation amount generated at a fixed time interval indicates the decoding of the data. A point of intersection of the inclined dotted line and the time axis in the graph (b) indicates a starting time of transferring data of the video frame to the video buffer.

The following describes an example of processing a complicated image A in the video data. As shown in (b) of FIG. 4, since an image requires a large amount of codes, the data should start to be transferred at a time t1 of (b), which is earlier than the decoding time of the image A, (a time period between the data input starting time and the decoding time will be called vbv, —delay). As a result, the image A is multiplexed as AV data at the position (.e., the corresponding time period) of a video pack VP1 in (c) of FIG. 4.

On the other hand, the audio data generally is multiplexed a short time before the decoding time, because the transfer of the audio data does not require such dynamic control of the amount of codes as required for the video, and therefore, it is not necessary to start the transfer of the audio data especially earlier than the decoding time. Therefore, as for the video data and the audio data to be reproduced at the same time, the multiplexing of these data is conducted so that the video data precedes the audio data.

Note here that the MPEG restricts a time period for permitting to store data in a buffer so that all data except for still image data should be output from the buffer to the decoder within one second after the data is input into the buffer. For that reason, a time lag between the multiplexing of the video data and the audio data should be within one second at most (strictly speaking, a further time lag might occur by the reordering of the video data).

Although this example describes a case where the video precedes the audio, the audio can precede the video theoretically. Such data can be generated intentionally by preparing a simple image with a high compression rate as video data and by transferring audio data earlier than required. However, because of the restriction by the MPEG, the preceding time period should be within one second.

The MPEG data, as described above, is multiplexed to be handled. The unit for this multiplexing is a unit called Video Object Unit (hereinafter referred to as VOBU).

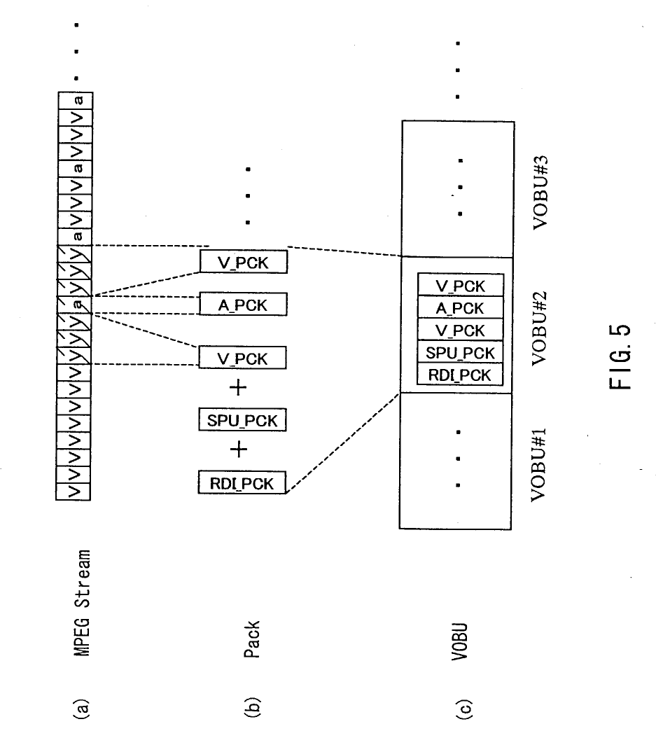

FIG. 5 shows a configuration of this VOBU. As shown in (c) of FIG. 5, the VOBU is configured with Real-Time Data Information pack (RDI_PCK) containing copyright and aspect information, audio pack (hereinafter referred to as A_PCK), sub-picture pack (SPU_PCK) and video pack (hereinafter referred to as V_PCK) including video data compressed according to the MPEG method. The A_PCK and the V_PCK are multiplexed so as to have a relationship in accordance with the above-described one-second rule.

Configuration of Recorded Data on DVD-RAMs

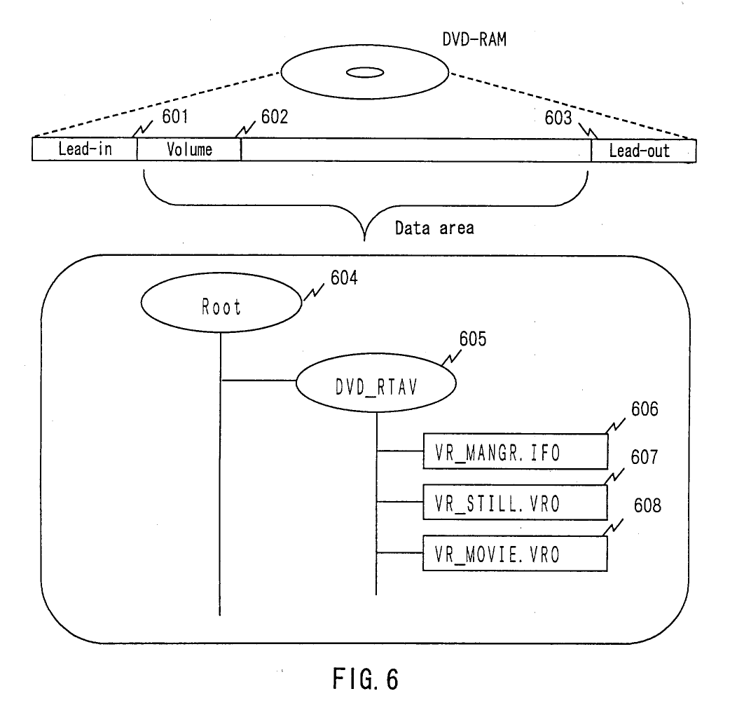

The following describes an example of the configuration of data recorded on the DVD-RAMs. FIG. 6 shows the data recorded on a DVD-RAM, concerning a physical configuration managed with physical sector addresses and a logical configuration managed with a file system. The file system refers to a system for managing data in the disc as directories and files.

In FIG. 6, numeral 601 denotes a lead-in area in which a standard signal required for stabilizing the servo and a signal for distinguishing from other media are recorded, 602 denotes a volume area in which management information for the file system is recorded and 603 denotes a lead-out area in which the standard signal similar to the lead-in area 601 is recorded. The lead-in area 601 and the lead-out area 603 are provided at the beginning and the ending of the, physical sector addresses, respectively. Between the lead-in area 601 and the lead-out area 603, a data area is present in which logically valid data is recorded. At the beginning of the data area, the volume area 602 is provided.

The logical configuration of the data in view of the file system will be described below. In FIG. 6, numeral 604 denotes a Root directory, 605 denotes a DVD_RTAV directory, 606 denotes a VR_MANGR. IFO file as a management information file, 607 denotes a VR_STILL. VRO file as a still image file and 608 denotes a VR_MOVIE. VRO file as a moving image file. In this way, all data recorded in the DVD-RAM are placed under the DVD_RTAV directory 605 immediately under the Root directory 604.

Files recorded in the DVD-RAM are classified roughly into two types. One type is a management information file and the other type is one or a plurality of AV files. The AV file further is classified into three files including moving image, still image and a sound dubbed on a still image. As information for managing these three AV files, one management information file is placed. In FIG. 6, the management information file corresponds to the VR_MANGR. IFO file 606, the still image file corresponds to the VR_STILL. VRO file 607 and the moving image file corresponds to the VR_MOVIE. VRO file 608.

Explanations of the DVR Standard

When AV data is recorded on a DVD-RAM in accordance with the DVR standard, a logical unit positioned at the highest level is a reproduction path, which is called Program Chain (hereinafter referred to as PGC). The PGC is configured with one or more programs (hereinafter referred to as PG). A partial reproduction section of the PGC and PG is represented by the unit of CELL. The CELL includes a moving image CELL making up a moving picture section and a still image CELL making up a still image section.

The physical unit corresponding to the CELL is Video Object (hereinafter referred to as VOB). The moving image CELL corresponds to a moving image VOB and the still image CELL corresponds to a still image VOB. The CELL refers to the entire or a portion of the VOB. The moving image VOB is configured with a plurality of VOBUs, whereas the still image VOB Group (VOG) is configured with one or more still image VOBs. With respect to the moving image VOB and the still image VOG, information called M_VOB₁ and S_VOGI respectively are set in the management information file, and the access to the moving image VOB and the still image VOG is performed via the information.

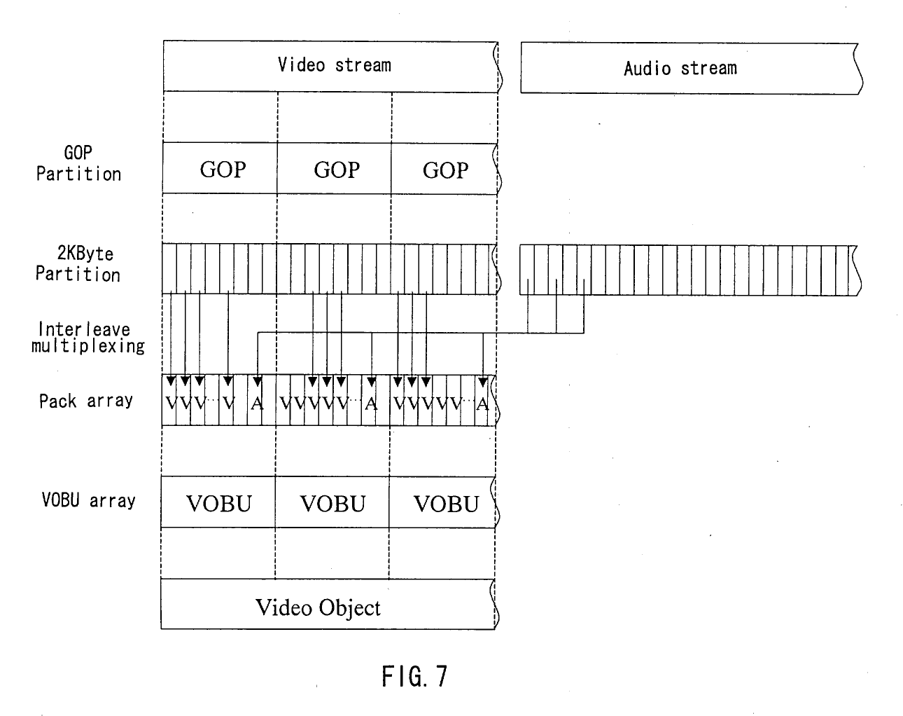

The internal configuration of the VOB will be explained below. FIG. 7 shows the detailed configuration of the VOB, illustrating each stage of the VOB. A VOB is a program stream obtained by multiplexing a video stream and an audio stream in accordance with the ISO/IEC 13818-1 standard, where Program End Code is not assigned to the end portion of the VOB. That is to say, a logical format located at each stage of FIG. 7 shows the details of a logical format located at a lower stage.

In FIG. 7, the video stream located at the first stage from the top is partitioned into a plurality of GOPs as shown in the second stage from the top. The picture data in the unit of GOP is partitioned into a plurality of 2-KByte units as shown in the third stage. On the other hand, the audio stream located on the right side of the first stage is partitioned into a plurality of about 2-KByte units as shown in the third stage.

The picture data in the unit of GOP, which is partitioned into 2 KBytes, is multiplexed with the audio stream partitioned into about 2 Kbytes in an interleaving manner to form a pack array shown at the fourth stage. Such pack array forms a plurality of VOBUs shown at the fifth stage, and the VOB shown at the sixth stage has a configuration in which a plurality of VOBUs are arranged according to the time sequence.

Dotted lines shown in FIG. 7 are for clarifying which part of the logical format at an upper stage is indicated in details by the logical format at a lower stage. Referring to the dotted lines in FIG. 7 based on this notation, it can be found that the VOBUs at the fifth stage correspond to the pack array shown at the fourth stage, and further correspond to the picture data in the unit of GOP shown at the second stage.

As is evident from the correspondences indicated by the dotted lines, the VOBU is the unit including at least one or more GOPs configured with picture data whose reproduction time is about 0.7 second to 1.0 second and audio data multiplexed with this picture data, and is configured with the arrangement of V_PCK and A_PCK in accordance with the MPEG standard.

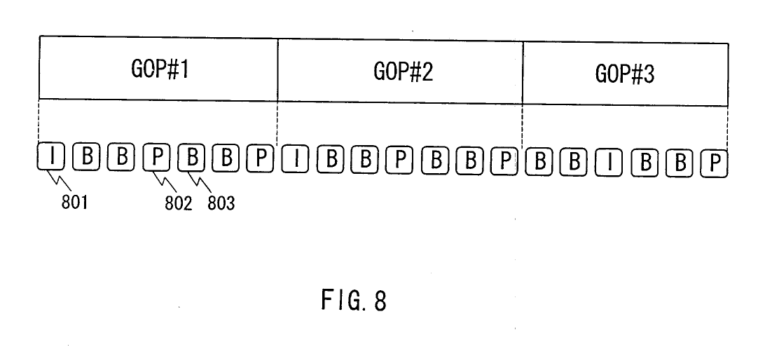

Next, the internal configuration of the GOP will be explained below. FIG. 8 shows the internal configuration of a GOP. In FIG. 8, numerals 801, 802 and 803 denote an I picture, B picture and P picture, respectively. As shown in FIG. 8, in each GOP, a plurality of pieces of picture data to be displayed in a frame are arranged, and constitutes a portion of a video stream, which corresponds to a reproduction time period of about 0.4 second to 1.0 second.

Configuration of the Digital Video Recording Apparatus

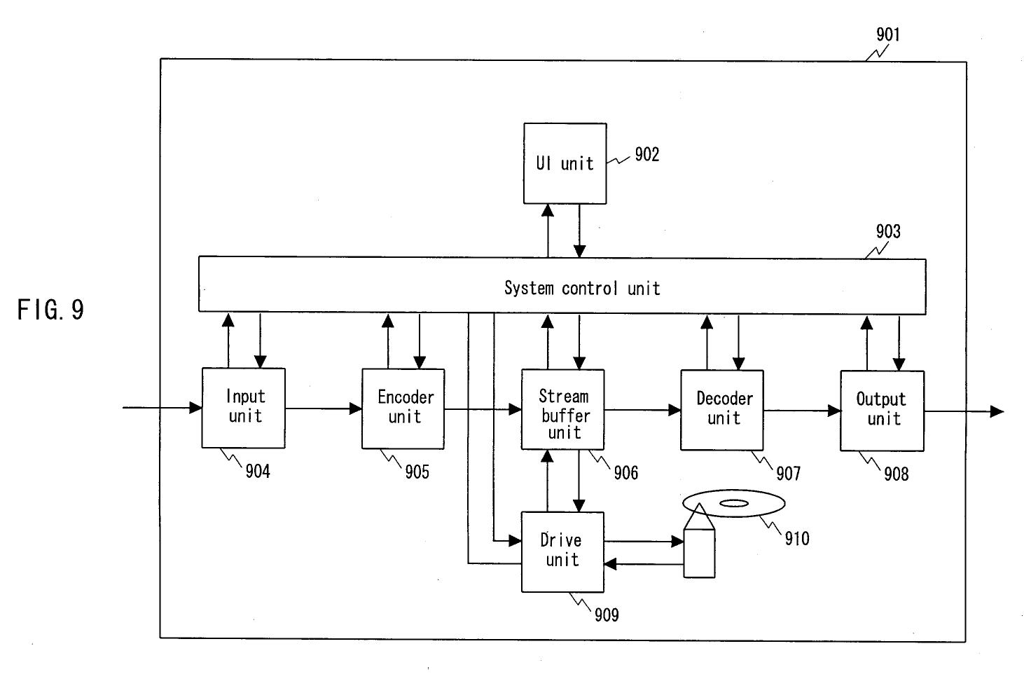

FIG. 9 is a block diagram showing functions of a digital video recording apparatus 901 according to this embodiment.

As shown in FIG. 9, the digital video recording apparatus includes a user interface (hereinafter referred to as Ul) unit 902, a system control unit 903, an input unit 904, an encoder unit 905, a stream buffer unit 906, a decoder unit 907, an output unit 908 and a drive unit 909. This apparatus employs a DVD-RAM 910 as a recording medium.

The UI unit 902 includes input devices such as operation keys and output devices such as a display device. The UI unit 902 accepts a request from a user to start the picture recording, start the reproduction and the like and transmits the accepted request to the system control unit 903.

The input unit 904 converts an audio video signal and the like, which is input through an external input terminal such as an antenna terminal, a tuner and an audiovisual input terminal, into frame data by means of an A/D converter. Then, the input unit 904 transmits the converted frame data to the encoder unit 905.

The output unit 908 converts the frame data transmitted from the decoder unit 907 into an audio video signal by means of a D/A converter. Then, the output unit 908 outputs the converted audio video signal to an external monitor through an external output terminal such as an audiovisual output terminal.

The encoder unit 905, when receiving an encode start instruction from the system control unit 903, starts an encode procedure. When receiving an encode stop instruction, the encoder unit 905 stops the encode procedure.

The encode procedure refers to a procedure of receiving frame data transmitted from the input unit 904 and coding the received frame data to generate data in a program stream format in accordance with the MPEG (hereinafter such data will be referred to as VOB). Also, every time a VOBU constituting the VOB is generated, the encoder unit 905 transmits VOBU information concerning the generated VOBU to the system control unit 903 and transmits the generated VOBU to the stream buffer unit 906. Then, the encoder unit 905 repeats the encode procedure until the encoder unit 905 receives an encode stop instruction from the system control unit 903.

The VOBU information refers to information including a starting time to reproduce a video frame in the VOBU (VOBU_S_PTM), a size of the first I picture from the beginning of the VOBU (Reference_Picture_Size), a size of the VOBU (VOBU_Size), a reproduction time (PB_Time), an aspect ratio, an audio mode, the number of audio streams and the like.

The decoder unit 907, when receiving a decode start instruction from the system control unit 903, starts a decode procedure. When receiving a decode stop instruction from the system control unit 903, the decoder unit 907 stops the decode procedure.

The decode procedure is a procedure of receiving a VOBU transmitted from the stream buffer unit 906 and reconstructing frame data from the received VOBU. The decoder unit 907 transmits the reconstructed frame data to the output unit 908. Then, the decoder unit 907 repeats the decode procedure until the decoder unit 907 receives a decode stop instruction from the system control unit 903.

The stream buffer unit 906 is configured with a recording medium, a buffer, a reading/writing control program and the like. In accordance with an instruction from the system control unit 903, the stream buffer unit 906 carries out a reading/writing procedure of management information and a VOBU. More specifically, when receiving a VOBU writing instruction from the system control unit 903, the stream buffer unit 906 carries out a VOBU writing procedure as described later. When receiving a VOBU reading instruction, the stream buffer unit 906 carries out a VOBU reading procedure as described later. When receiving a management information writing instruction, the stream buffer unit 906 carries out a management information writing procedure as described later. When receiving a management information reading instruction, the stream buffer unit 906 carries out a management information reading procedure as described later.

The VOBU writing procedure refers to a procedure of receiving a VOBU transmitted from the encoder unit 905, storing the received VOBU in the buffer, writing the VOBU stored in the buffer to the recording medium and clearing the buffer. When writing the VOBU to the recording medium, if a writing error occurs, the system control unit 903 is informed of the writing error.

The VOBU reading procedure refers to a procedure of reading a VOBU written on the recording medium, storing the read VOBU in the buffer, transmitting the VOBU stored in the buffer to the decoder unit 907 and clearing the buffer.

The management information writing procedure refers to a procedure of receiving management information transmitted from the system control unit 903 and storing the received management information in the recording medium as a management information file.

The management information reading procedure refers to a procedure of reading management information stored in the management information file and transmitting the read management information to the system control unit 903. If the management information file is not stored in the recording medium, the system control unit 903 is informed of a reading error.

Here, the management information includes reproduction control information calculated from the VOBU information that is received during the picture recording. On completing the picture recording, the management information is stored in the recording medium as a management information file. Then, during reproduction, the management information indicates information that is referred to by the system control unit 903 and for controlling the reproduction of a VOBU (or VOB) stored in the recording medium. According to the DVR standard, the management information is recorded as a VR_MANGR. IFO file.

Basic Operation of the Apparatus

The basic operation of the digital video recording apparatus 901 will be described below.

To begin with, a recording operation will be described, with reference to FIG. 9. When being instructed from the UI unit 902 to execute a recording operation of a program, the system control unit 903 starts the recording operation of video stream information. In the input unit 904, the input information is converted from an analog signal to a digital signal by means of the A/D converter. The encoder unit 905 compresses the digital information transmitted from the input unit 904 and outputs the same to the stream buffer unit 906. The stream buffer unit 906 temporarily stores the compressed video stream information and the like, and then outputs the same to the drive unit 909. The drive unit 909 performs the writing to the DVD-RAM 910. The compressed video stream information and the like are recorded at the designated position in the DVD-RAM 910 under the control by the system control unit 903. According to the DVR standard, the video stream information is recorded as a VR_MOVIE. VRO file. When being instructed from the UI unit 902 to stop the recording, the system control unit 903 stops the recording operation of the video stream information.

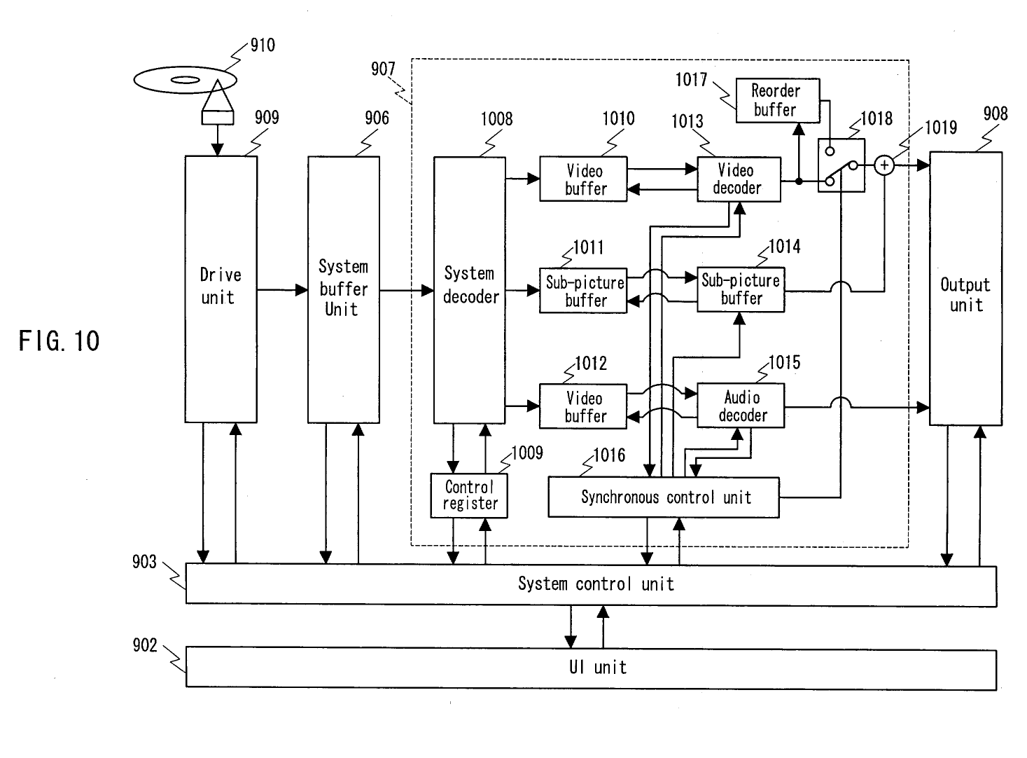

Next, a reproduction operation of recorded data will be described, with reference to FIG. 10. FIG. 10 is a block diagram showing a portion of the digital video recording apparatus according to this embodiment in detail that contributes to the reproduction. In FIG. 10, the same reference numerals as in FIG. 9 are assigned to the elements described above with reference to FIG. 9, and an internal configuration of the decoder unit 907 is illustrated in detail.

As shown in FIG. 10, the decoder unit 907 includes a system decoder 1008, a control register 1009, a video buffer 1010, a sub-picture buffer 1011, an audio buffer 1012, a video decoder 1013, a sub-picture decoder 1014, an audio decoder 1015, a synchronous control unit 1016, a reorder buffer 1017, a selector 1018 and a synthesizer unit 1019.

When being instructed from the UI unit 902 to execute a reproduction operation of the recorded data, the system control unit 903 starts the reproduction operation. The drive unit 909 reads out digital information (compressed video stream information and the like) from the DVD-RAM 910.

The stream buffer unit 906 has a predetermined buffer capacity to allow a reproduction signal bit stream input from the drive unit 909 to be stored temporarily, and extracts address information and synchronous initial value data of each stream to generate stream control data. The stream buffer unit 906 is connected with the system control unit 903, so that the generated stream control data is supplied to the system control unit 903.

The synchronous control unit 1016 of the decoder unit 907, which is connected to the system control unit 903, receives the synchronous initial value data (SCR) included in the synchronous control data, sets the SCR at an internal system clock (STC), and supplies the system control unit 903 with the reset system clock.

The system control unit 903 generates a stream read-out signal at predetermined intervals according to the system clock and inputs the same to the stream buffer unit 906. The read-out unit in this case is a pack.

Here, a method for generating the stream read-out signal will be explained below. The system control unit 903 makes a comparison between the SCR in the stream control data extracted from the stream buffer unit 906 and the system clock from the synchronous control unit 1016, and at the timing when the system clock becomes larger than the SCR in the stream control data, the system control unit 903 generates a read-out request signal. By conducting such control in the unit of a pack, the transmittance of packs is controlled.

The system control unit 903 generates a decode stream instruction signal that indicates an ID of each of the streams including video, sub-picture and audio streams, which corresponds to the selected recorded data in accordance with an instruction by the user's designation through the UI unit 902 and outputs the same to the system decoder 1008 through the control register 1009.

In accordance with the instruction of the decode instruction signal, the system decoder 1008 outputs the video, sub-picture and audio streams input from the stream buffer unit 906 to the respective buffers, where the video stream is output to the video buffer 101 as a video encode stream, the sub-picture stream is output to the sub-picture buffer 1011 as a sub-picture encode stream and the audio stream is output to the audio buffer 1012 as an audio encode stream. That is to say, when the ID of the stream corresponding to the recorded data instructed from the UI unit 902 agrees with the ID of a pack transmitted from the stream buffer unit 906, the corresponding pack is transferred to the respective buffers (the video buffer 1010, the sub-picture buffer 1011 and the audio buffer 1012).

The system decoder 1008 detects a reproduction starting time (PTS) and a decode starting time (DTS) in each of the minimum control units of each stream to generate a time information signal. This time information signal is transmitted to the system control unit 903 through the control register 1009 and is input to the synchronous control unit 1016 as synchronous control data.

The synchronous control unit 1016 determines a decode start timing for each stream in accordance with this time information signal so that each of the streams can be in the predetermined order as a consequence of the decoding. The synchronous control unit 1016 generates a video stream decode starting signal in accordance with this decode timing and inputs the same to the video decoder 1013. Similarly, the synchronous control unit 1016 generates a sub-picture decode starting signal and an audio decode starting signal and inputs them to the sub-picture decoder 1014 and the audio decoder 1015, respectively.

The video decoder 1013 generates a video output request signal in accordance with the video stream decode starting signal and outputs the same to the video buffer 1010. The video buffer 1010 receives the video output request signal and outputs a video stream to the video decoder 1013. The video decoder 1013 detects reproduction time information included in the video stream, and at the timing when the video stream in size equivalent to the reproduction time has been input, the video decoder 1013 makes the video output request signal invalid. In this way, the video stream equivalent to the predetermined reproduction time is decoded by the video decoder 1013, and the reproduced video signal is output to the reorder buffer 1017 and the selector 1018.

Since the video encode stream is subjected to the coding utilizing a correlation between frames in accordance with the MPEG standard as previously described, the order of display and the order of coding do not agree with each other in terms of the unit of frames. Therefore, it cannot be displayed in the decoding order. For that reason, frames subjected to the decoding are stored in the reorder buffer 1017 temporarily. The synchronous control unit 1016 controls the selector 1018 to be switched between the output of the video decoder 1013 and the output of the reorder buffer 1017 so that the frames are aligned in the display order to be output to the synthesizer unit 1019.

Similarly, the sub-picture decoder 1014 generates a sub-picture output request signal in accordance with the sub-picture decode starting signal and supplies the same to the sub-picture buffer 1011. In response to the sub-picture output request signal, the sub-picture buffer 1011 outputs a sub-picture stream to the sub-picture decoder 1014. The sub-picture decoder 1014 decodes a sub-picture stream in size equivalent to a predetermined reproduction time in accordance with reproduction time information included in the sub-picture stream to reproduce a sub-picture signal and output the same to the synthesizer unit 1019.

The synthesizer unit 1019 superimposes the output from the selector and the sub-picture signal to generate a visual signal and output the same to the output unit 908.

The audio decoder 1015 generates an audio output request signal in accordance with the audio decode starting signal and supplies the same to the audio buffer 1012. In response to the audio output request signal, the audio buffer 1012 outputs an audio stream to the audio decoder 1015. The audio decoder 1015 decodes an audio stream in size equivalent to a predetermined reproduction time in accordance with reproduction time information included in the audio stream and outputs the same to the output unit 908.

The output unit 908 converts the decoded digital video signal and digital audio signal from the digital signal to an analog signal by the D/A conversion and outputs the same to a TV set and the like that is connected to the output unit 908.

Embodiment 1

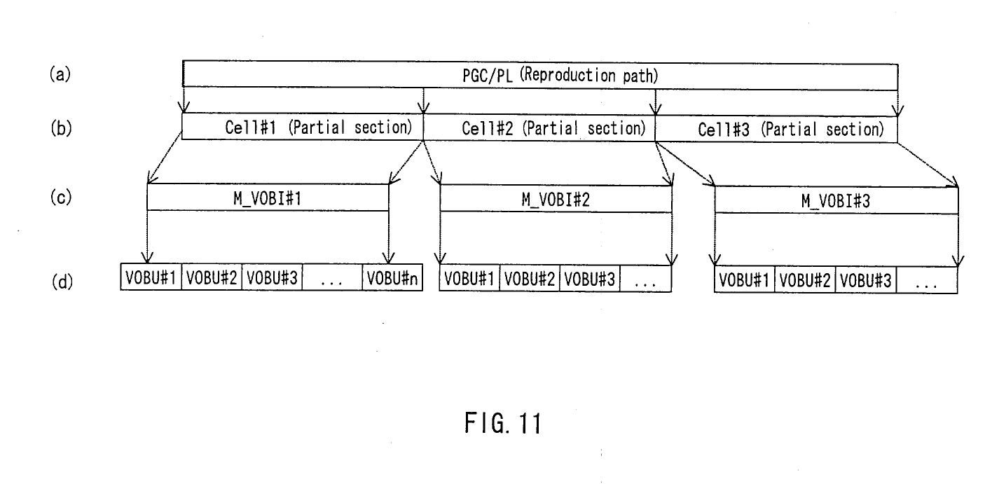

The following specifically describes an example of a seamless reproduction operation of the digital video recording apparatus according to this embodiment having the above-stated configuration, with reference to FIGS. 11 to 17.

FIG. 11 shows a relationship among PGC, CELL, VOBU and management information M_VOBI. In FIG. 11, (a) shows the PGC as a reproduction path, (b) shows a CELL corresponding to the PGC, (c) shows M_VOBI as the management information corresponding to each CELL and (d) shows a VOBU designated by each M_VOBI.

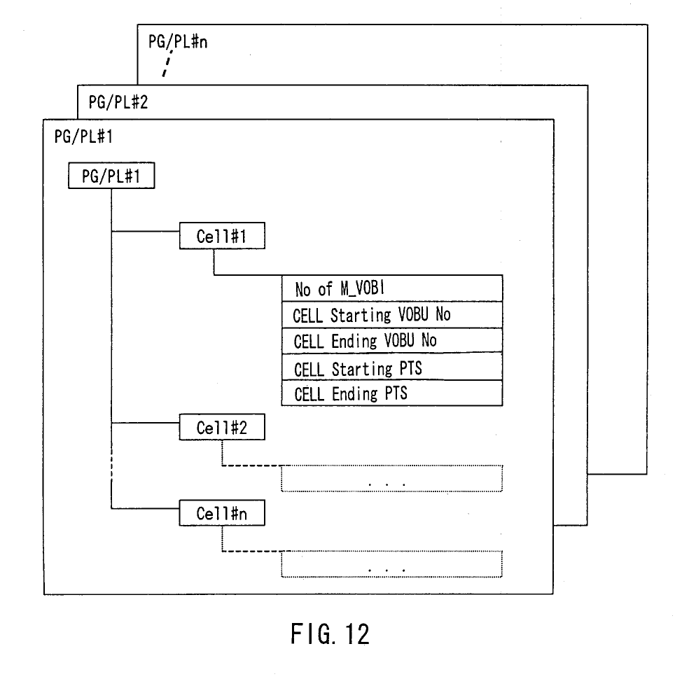

FIG. 12 is a schematic representation of the management information concerning PG or PL. The PG or PL is configured with a plurality of CELLs, and the number of M_VOBI, the number of the starting VOBU in the CELL, the number of the ending VOBU in the CELL, the starting PTS in the CELL and the ending PTS in the CELL are described as the information for each CELL.

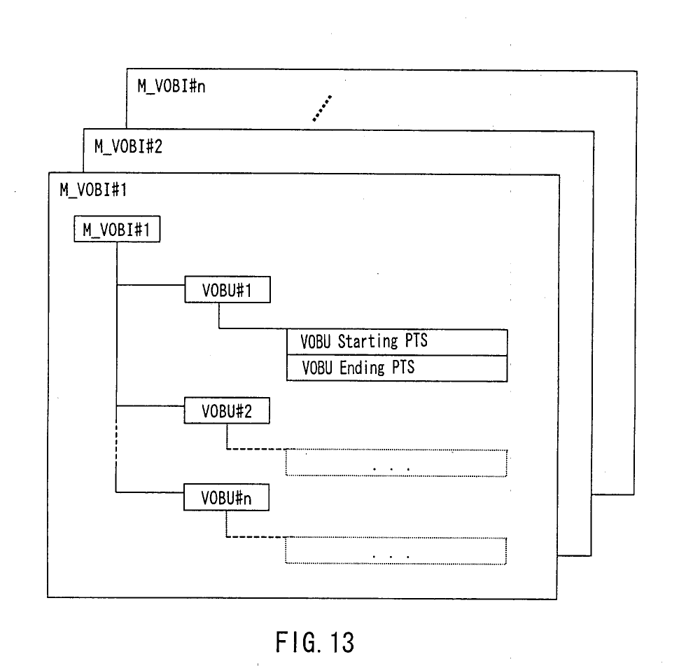

FIG. 13 is a schematic representation of the management information M_VOBI of FIG. 11. In the M_VOBI, the starting PTS and the ending PTS of each of the VOBUs that constitute the CELL are described.

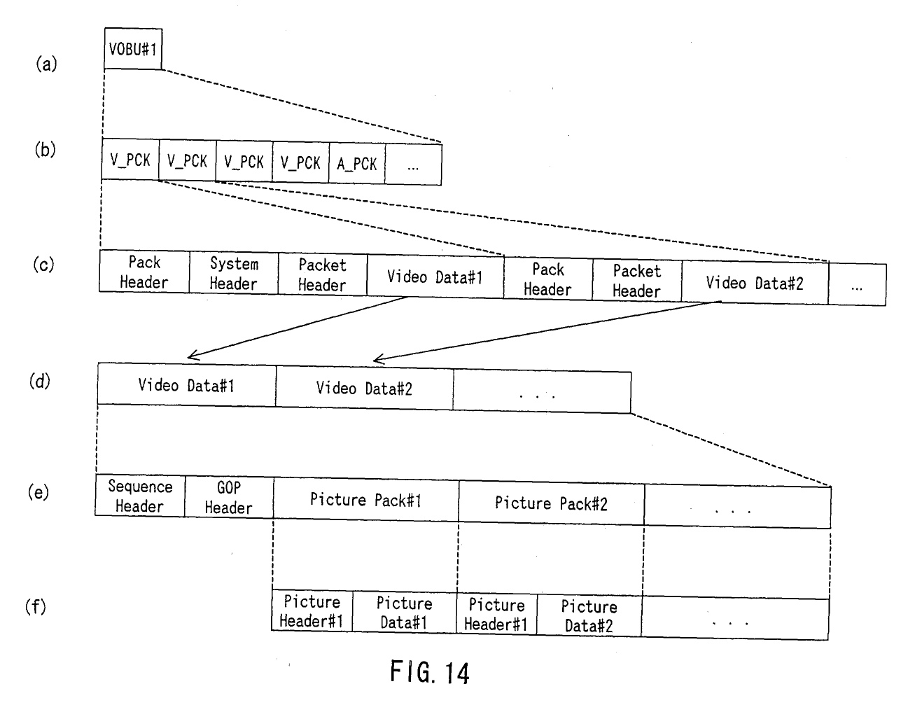

FIG. 14 shows a data configuration of V_PCK in the VOBU. In FIG. 14, (a) shows a VOBU. FIG. 14(b) represents that the VOBU is configured with V_PCK and A_PCK, (c) represents that the V_PCK is configured with Pack Header, System Header, Packet Header and Video Data, (d) shows the Video Data that is decoded from V_PCK by a system decoder, (e) represents that the Video Data is configured with Sequence Header, GOP Header and Picture Pack and (f) represents that the Picture Pack is configured with Picture Header and Picture Data.

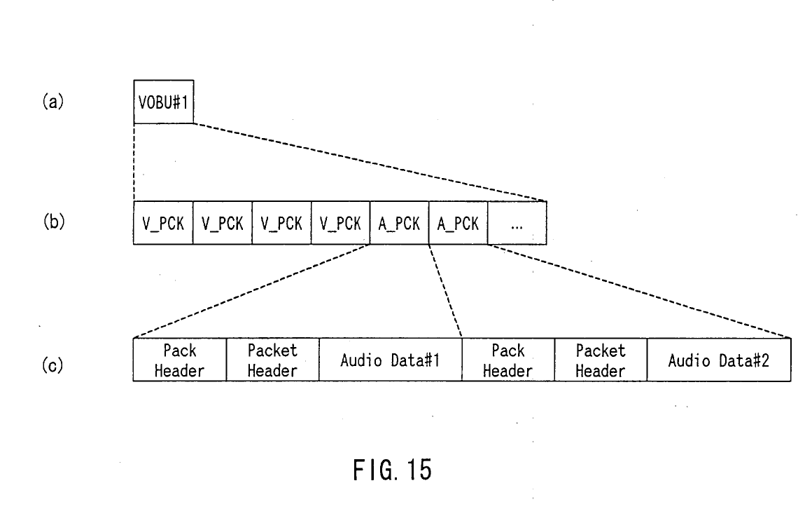

FIG. 15 shows a data configuration of A_PCK in the VOBU. In FIG. 15, (a) shows a VOBU. FIG. 15(b) represents that the VOBU is configured with V_PCK and A_PCK and (c) represents that the A_PCK is configured with Pack Header, Packet Header and Audio Data.

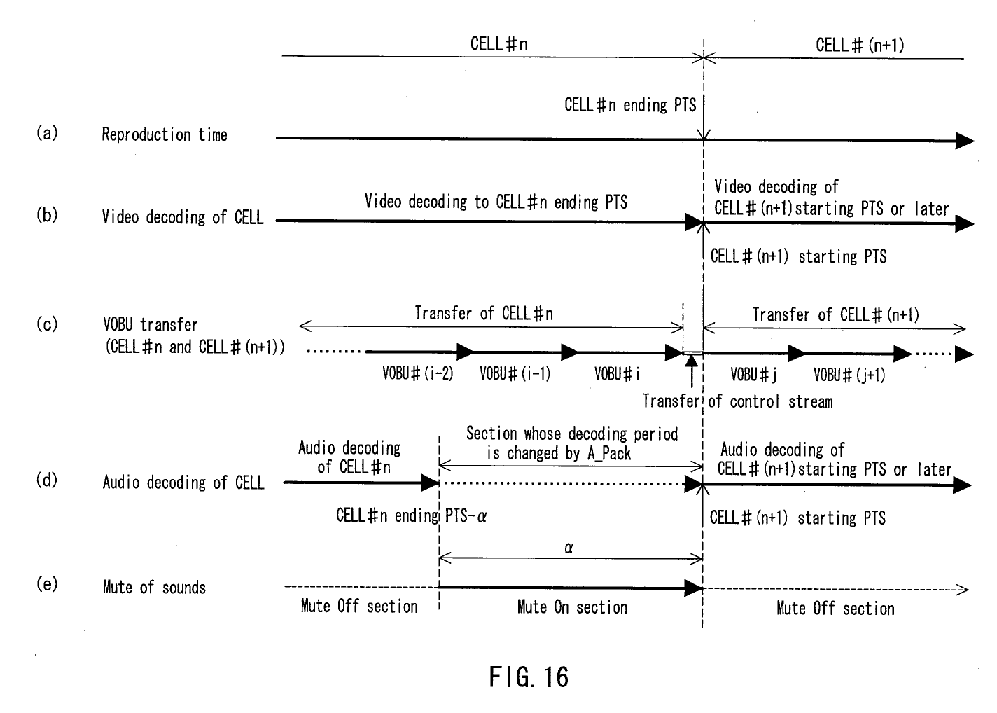

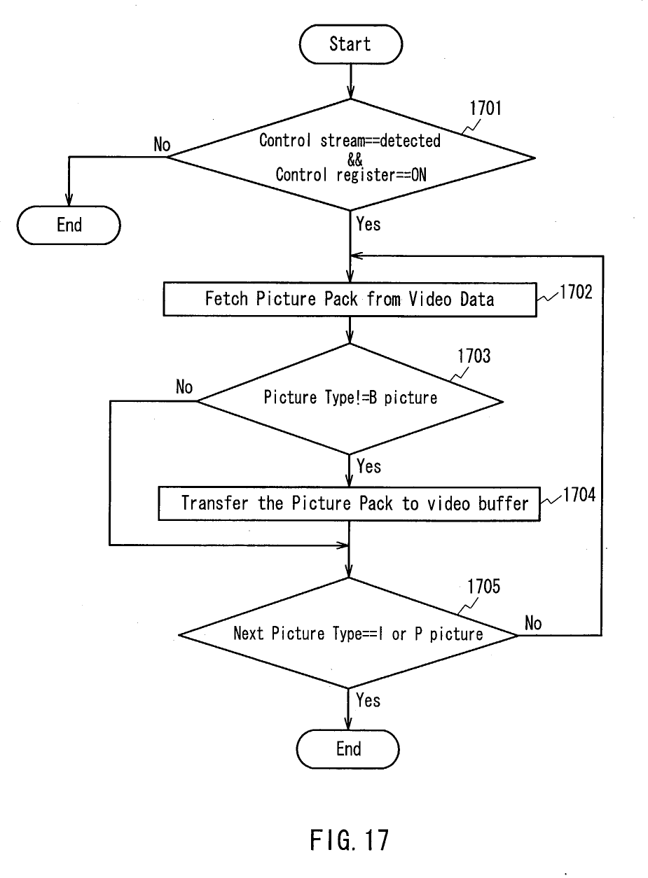

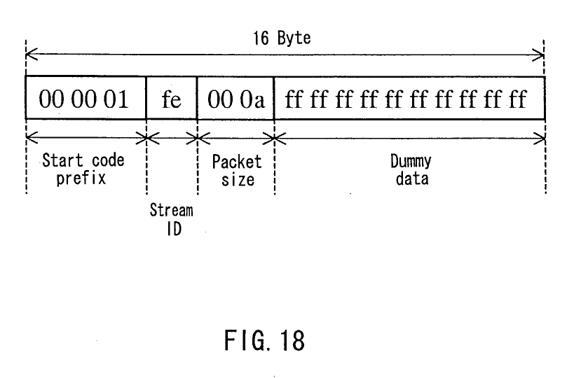

FIG. 16 is a timing chart showing the reproduction operation according to this embodiment. FIG. 17 is a flowchart of the reproduction operation according to this embodiment. FIG. 18 shows an example of a control stream for performing the seamless reproduction.

When being instructed from a user to start the reproduction of PL through the UI unit 902, the system control unit 903 starts the reproduction operation. The system control unit 903 refers to the management information of the PL of FIG. 11, selects a piece of M_VOBI in accordance with the information on the number of the M_VOBI in the first CELL#1 and designates the CELL starting VOBU number to the CELL ending VOBU number in the CELL#1 as the VOBU starting position to the VOBU ending position. The system control unit 903 turns a control bit of the system decoder 1008 for performing the seamless reproduction ON through the control register 1009. The system control unit 903 reads the VOBU stream between the determined VOBU starting position and the VOBU ending position into the stream buffer unit 906 sequentially in the order indicated by (c) of FIG. 16.

Next, the system control unit 903 transfers the VOBU, read into the stream buffer unit 906 corresponding to one CELL, from the stream buffer unit 906 to the system decoder 1008 in the read order. In this procedure, every time the transfer of the VOBU corresponding to one CELL has been completed, the system control unit 903 inputs a control stream indicating the achievement of the connecting point of CELLs. That is to say, as shown in FIG. 16(c), the system control unit 903 inserts the control stream after the VOBU#i as the final VOBU in the CELL#n and before the VOBU#j as the head VOBU in the next CELL#(n+1).

Note here that the control stream may be Sequence End Code prescribed by the MPEG standard, or a special code for facilitating the distinction such as a code shown in FIG. 18. In the example of FIG. 18, FEh as one of the currently not used IDs is used for the stream ID, and the data of 10 bytes all of which are 1 is used as dummy data. This control stream may be any data insofar as the system decoder 1008 can detect it, but data that is not present in the MPEG stream is preferable.

After the insertion of the control stream has been completed, the system control unit 903 determines the VOBU starting position and the VOBU ending position for the next CELL#(n+1) in accordance with the management information of the CELL#(n+1) as described above to continue the input of the stream.

The system decoder 1008, as shown in FIGS. 14 and 15, separates the VOBU input from the stream buffer unit 906 into V_PCK and A_PCK. The system decoder 1008 further decodes the V_PCK into the form of Video Data. Next, the system decoder 1008 fetches Picture Pack from a plurality pieces of Video Data. The system decoder 1008 transfers the fetched Picture Pack to the video buffer 1010.

During the procedure by the system decoder 1008, the system decoder 1008 detects the control stream input at the head of the CELL#(n+1) by the system control unit 903. If the control bit of the control register 1009 for performing the seamless reproduction is ON (a result from the step 1701 shown in FIG. 17 is Yes), the system decoder 1008 fetches Picture Pack from the stream buffer (step 1702) and judges a picture type using the Picture Type value in the Picture Header of the Picture Pack (step 1703).

If the picture type is a B picture is a forward-referring type (a result from the step 1703 is No), the system decoder 1008 does not transfer the fetched Picture Pack to the video buffer 1010. In other cases (a result from the step 1703 is Yes), the system decoder 1008 transfers the fetched Picture Pack to the video buffer 1010. This procedure is for securing a normally decoded image by deleting the Picture Pack incapable of being decoded, because the video decoder 1010 cannot conduct the video decoding normally using forward-referring type B pictures.

The system decoder 1008 judges the Picture Type value in the Picture Header of the next Picture Pack. If the value does not indicate either an I picture or a Picture (a result from the step 1705 is No), the system decoder 1008 returns to the step S1702 to conduct the procedure of this flow. If the value indicates an I picture or a P picture (a result from the step 1705 is Yes), the procedure of this flowchart is completed to continue the normal procedure.

According to the above procedure, the video decoder 1013 can conduct the MPEG decoding of Picture Packs of the CELL#n and CELL#(n+1) that are input into the vide buffer 1010 sequentially, thus enabling the seamless output of the reproduced data.

The following describes the mute procedure of sounds, with reference to FIGS. 16(d) and (e). The system control unit 903 performs the control using the PTS input from the synchronous control unit 1016. Every time a Picture Pack is reproduced, the video decoder 1013 calculates PTS and inputs the PTS to the synchronous control unit 1016. The system control unit 903 monitors the PTS input into the synchronous control unit 1016, and when the value of the PTS becomes at a time of (CELL#n ending PTS−α), the system control unit 903 instructs the output unit 908 to start a mute procedure of sounds. When the reproduction is continued to the termination of the CELL#n and the PTS changes to the CELL ending PTS, the system control unit 903 instructs the output unit 908 to stop the mute procedure of sounds.

As the above time α, a value in accordance with the multiplexing rule of the audio pack A_PCK and the visual pack V_PCK of the MPEG is adopted. This value is adopted under the assumption that the A_PCK is not present until up to one second before the termination of the CELL, because the multiplexing according to the MPEG permits V_PCK and the corresponding A_PCK to be located in the VOBUs at a maximum interval of one second therebetween. Since this rule might vary with the multiplexing rule of the adopted encoder, the value of α may be changed to a value in accordance with the multiplexing rule of the adopted encoder. By conducting a fade-in/out operation instead of the mute operation of sounds, the control with a higher quality can be provided for the sound quality.

Embodiment 2

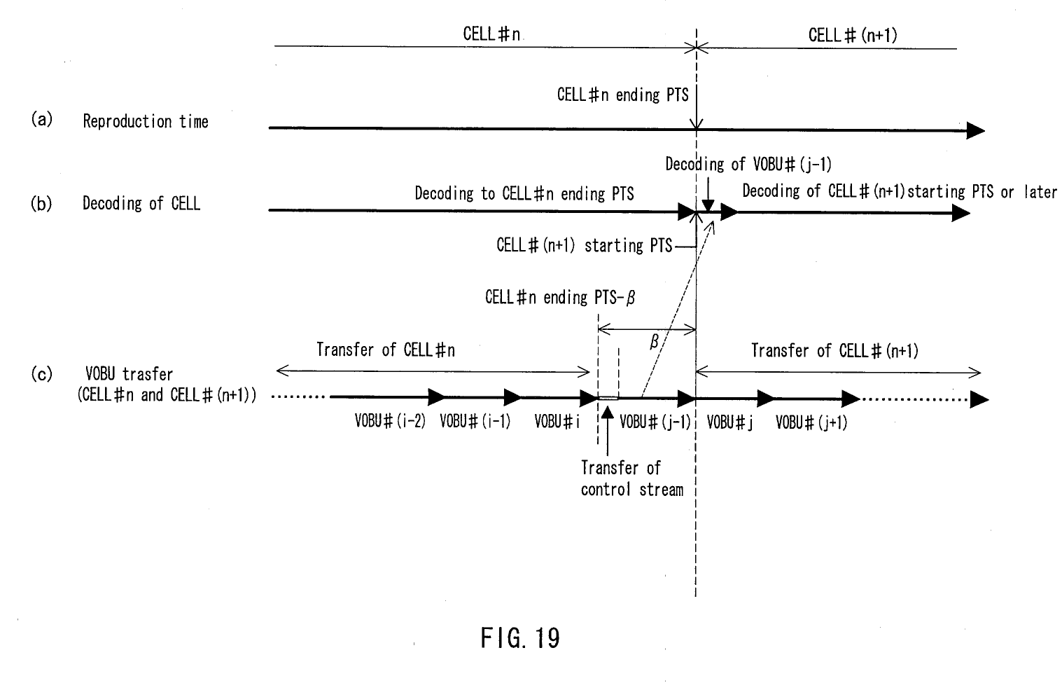

The following describes another specific example of the reproduction operation of the digital video recording apparatus according to this embodiment, with reference to FIG. 19. For simplifying the description, only the portion that is different from Embodiment 1 will be described below. FIG. 19 is a timing chart of the reproduction operation according to this embodiment.

This embodiment is under the assumption that the decoding capability of the video decoder is at lxspeed. This embodiment is different from Embodiment 1 in that at the time when the transfer of VOBUs corresponding to the CELL#n has been completed, a control stream indicating the achievement of the connecting point is input, and then the system control unit 903 continuously inputs VOBU#(j−1) including a picture referred to by the head B picture in the head VOBU#j of the next CELL#(n+1). In this case, although the CELL#(n+1) is reproduced from the VOBU#(j−1), there is no need to cancel the decoding of the head B picture in the VOBU#j.

Embodiment 3

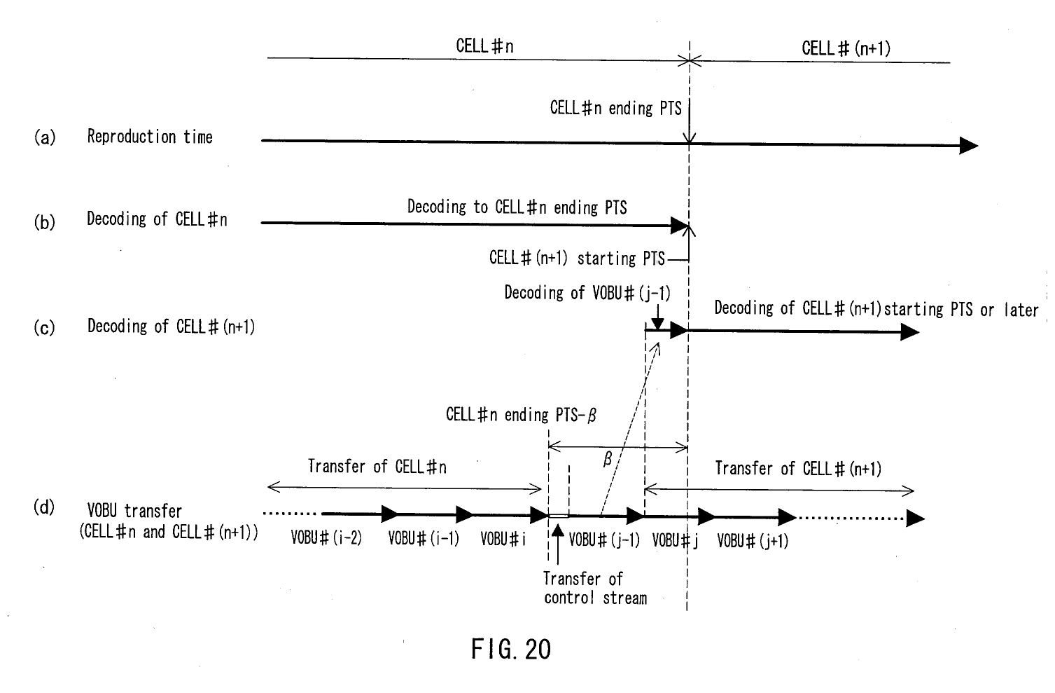

The following describes still another specific example of the reproduction operation of the digital video recording apparatus according to this embodiment, with reference to FIG. 20. For simplifying the description, only the portion that is different from Embodiment 1 will be described below. FIG. 20 is a timing chart of the reproduction operation according to this embodiment.

This embodiment is under the assumption that the decoding capability of the video decoder is at double speed or higher. As in the case of Embodiment 2, this embodiment also is different from Embodiment 1 in that at the timing when the transfer of VOBUs corresponding to the CELL#n has been completed, a control stream indicating the achievement of the connecting point is input, and then the system control unit 903 continuously inputs VOBU#(j−1) including a picture referred to by the head B picture in the head VOBU#j of the next CELL#(n+1).

However, since the decoding capability of the video decoder in this embodiment is at double speed or higher as shown in FIGS. 20(b) and (c), the VOBU#(j−1) including the picture referred to by the head B picture in the head VOBU#J of the CELL#(n+1) can be decoded simultaneously with the decoding of the VOBU at the termination portion of the CELL#n. Thereby, without canceling the decoding of the head B picture in the VOBU#j, the CELL#(n+1) can be reproduced from the B picture in the VOBU#j.

Embodiment 4

When a user designates each reproduction section of the PL, arbitrary frames in the CELL can be designated as the starting point and the ending point. Therefore, in general, the starting point and the ending point of each reproduction section in the PL might not agree with the boundaries of a VOBU as the reproduction fundamental unit of the MPEG. This particular embodiment is effective for improving the user's operational ease in such a case by combining the above-described Embodiments 1 to 3.

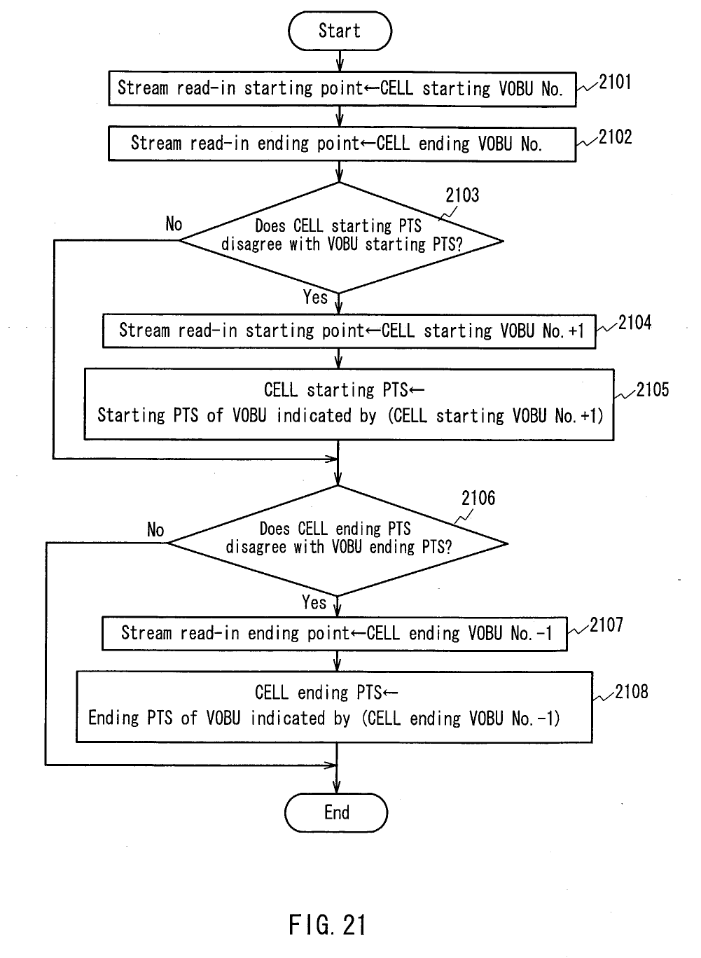

The following describes the reproduction operation of the digital video recording apparatus according to this embodiment, with reference to FIG. 21. For simplifying the description, only the portion that is different from Embodiments 1 to 3 will be described below. FIG. 21 is a timing chart of the reproduction operation according to this embodiment.

When being instructed to start the reproduction, a PL reproduction instruction selected by the UI unit 902 is transmitted to the system control unit 903. The system control unit 903 designates the initial value of the starting point to read out the stream from a disc as a CELL starting VOBU number (step 2101 of FIG. 21), and designates the initial value of the ending point to read out the stream from the disc as a CELL ending VOBU number (step 2102).

In accordance with the number information of M_VOBI in the first CELL (referred to as CELL#1) belonging to the PL, the system control unit 903 selects M_VOB, and judges whether the position designated by a user as the starting point (CELL starting PTS) agrees with the VOBU starting PTS of the VOBU indicated by the CELL starting VOBU number of the CELL#1 (step 2103). In the case of disagreement, the VOBU immediately behind the CELL starting VOBU number is designated as the starting point to read out the stream from the disc (step 2104). Then, the CELL starting PTS is substituted with the newly determined VOBU starting PTS (step 2105). In the case of agreement, the initial value of the starting point to read out the stream from the disc is kept as the VOBU starting PTS of the VOBU indicated by the CELL starting VOBU number.

Next, the system control unit 903 judges whether the position designated by the user as the ending point (CELL ending PTS) agrees with the VOBU ending PTS of the VOBU indicated by the CELL ending VOBU number of the CELL#1 (step 2106). In the case of disagreement, the VOBU ending PTS of the VOBU immediately preceding the VOBU indicated by the CELL ending VOBU number of the CELL#1 is designated as the ending point to read out the stream from the disc (step 2107). Then, the CELL ending PTS is substituted with the newly determined VOBU ending PTS (step 2108). In the case of agreement, the initial value of the ending point to read out the stream from the disc is kept as the VOBU ending PTS of the VOBU indicated by the CELL ending VOBU number.

In this way, when the starting point and the ending point of the CELL information do not agree with the boundaries of the VOBU, by providing the rounding procedure so that the VOBUs at the both end portions of a reproduction section are not included in the reproduction section, this embodiment exerts the effect of making reproduction sections other than that designated by a user invisible to the user.

Embodiment 5

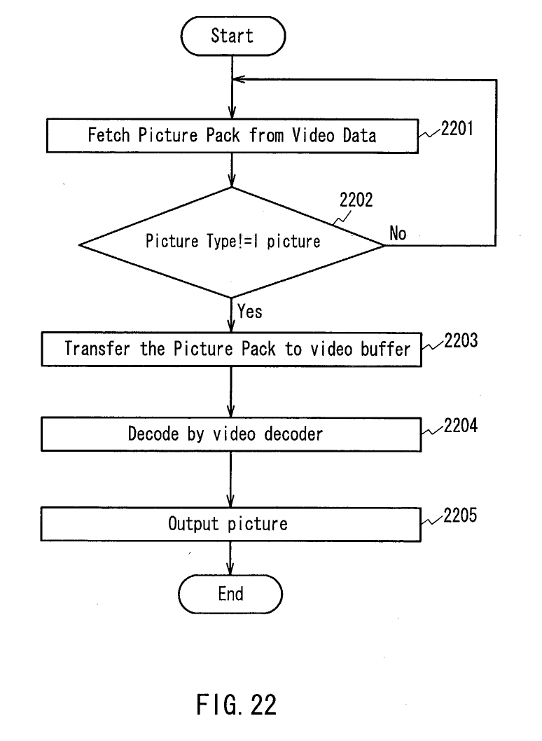

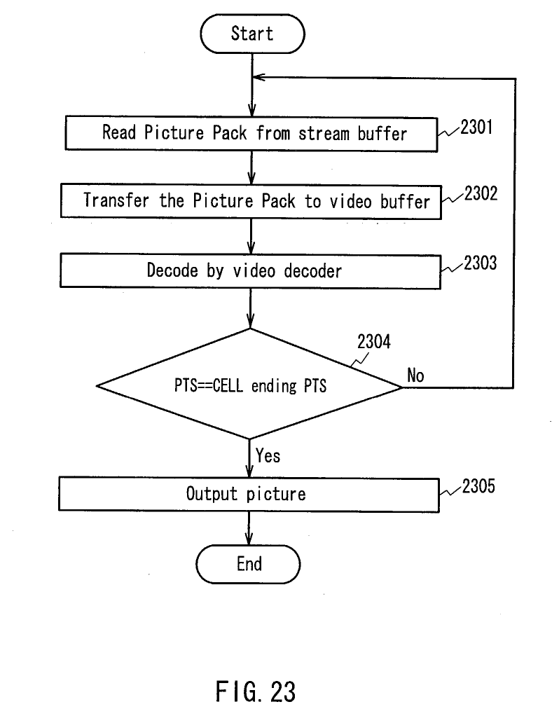

The following describes a further specific example of the reproduction operation of the digital video recording apparatus according to this embodiment, with reference to FIGS. 22 and 23. For simplifying the description, only the portion that is different from Embodiment 1 will be described below.

FIGS. 22 and 23 are flow charts of the reproduction operation according to this embodiment.

When a user edits the PL, the user specifies the starting point and the ending point of an arbitrary frame in the CELL of a PG to determine the CELL in the PL. In general, during this process, the user often instructs the frame-advance reproduction such as fast-forward or fast-rewind of the PG.

When the user instructs the frame-advance reproduction of the PG to specify the starting point of the PL through the UI unit 902, the system control unit 903 starts the frame-advance reproduction operation. The system control unit 903 refers to the management information of the PG of FIG. 12 to select a piece of M_VOBI in accordance with the number information of the M_VOBI in the first CELL#1 and designates the CELL starting VOBU number to the CELL ending VOBU number in the CELL#1 as the VOBU starting position to the VOBU ending position. The system control unit 903 sequentially reads the VOBU stream between the determined VOBU starting position and the VOBU ending position into the stream buffer unit 906.

Next, the system control unit 903 sequentially transfers the read VOBUs are transferred from the stream buffer unit 906 to the system decoder 1008 in the read order. The system decoder 1008 separates the VOBU input from the stream buffer unit 906 into V_PCK and A_PCK. The system decoder 1008 further decodes the V_PCK into the form of Video Data. Next, the system decoder 1008 fetches Picture Pack from a plurality of pieces of Video Data. The system decoder 1008 fetches the Picture Pack from the stream buffer unit 906 (step 2201 of FIG. 22) and only when the Picture Type value in the Picture Header of the Picture Pack indicates an I picture (a result from step 2202 is Yes), the system decoder 1008 transfers the Picture Pack to the video buffer 1010 (step 2203). Such a process will be repeated the number of times equal to the read VOBUs.

When the user instructs the frame-advance reproduction of the PG to specify the ending point of the PL through the UI unit 902, the system control unit 903 starts the frame-advance reproduction operation. The system control unit 903 refers to the management information of the PG of FIG. 12 to select a piece of M_VOBI in accordance with the number information of the M_VOBI in the first CELL#1 and designates the CELL starting VOBU number to the CELL ending VOBU number in the CELL#1 as the VOBU starting position to the VOBU ending position. The system control unit 903 sequentially reads the VOBU stream between the determined VOBU starting position and the VOBU ending position into the stream buffer unit 906.

Next, the read VOBUs are transferred sequentially from the stream buffer unit 906 to the system decoder 1008 in the read order. The system decoder 1008 separates the VOBU input from the stream buffer unit 906 into V_PCK and A_PCK. The system decoder 1008 further decodes the V_PCK into the form of Video Data. Next, the system decoder 1008 fetches Picture Pack from a plurality pieces of Video Data (step 2301 shown in FIG. 23) and transfers the fetched Picture Pack to the video buffer 1010 (step 2302). The system control unit 903 performs the control using the PTS input from the synchronous control unit 1016. Every time a Picture Pack is reproduced, the video decoder 1013 calculates PTS and inputs the PTS to the synchronous control unit 1016. The system control unit 903 monitors the PTS input into the synchronous control unit 1016, and when the PTS agrees with the CELL ending PTS (a result from step 2303 is Yes), the image is output (step 2304). Such a process will be repeated the number of times equal to the read VOBUs.

As a result of the above-stated operation in which the PL reproduction methods in Embodiments 1 to 3 are combined, the effect of making reproduction sections other than that designated by a user invisible to the user is exerted, when the user specifies the CELL in the PL.

Note here that although the above-stated Embodiments 1 to 5 are described as specific examples where the MPEG is employed as the coding standard of the AV data, the present invention is not limited to the MPEG, but is applicable to any apparatus for performing seamless reproduction of an AV data stream in accordance with the other coding standards.

Additionally, although the above-stated Embodiments 1 to 5 describe the example of DVD-RAM as the recording medium used in the reproduction apparatus of the present invention, any media can be used insofar as they can record AV data thereon.

According to the present invention, when arbitrary scenes in an AV data stream are connected in an arbitrary order to be reproduced, a reproduction apparatus that enables seamless reproduction by which a user does not recognize the connecting point of the scenes can be provided.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A reproduction apparatus that decodes a coded AV data stream and reproduces the decoded AV data stream, comprising:
a control data insertion unit for, in seamless reproduction to connect reproduction sections specified in the AV data stream in an arbitrary order, inserting seamless reproduction control data between the reproduction sections to be connected;
a control data detection unit for detecting the seamless reproduction control data in the AV data stream to be reproduced; and
a decoding cancel unit that, when the control data detection unit detects seamless reproduction control data and if one or a plurality of consecutive forward-referring type pictures are present at a head of the reproduction section following the detected seamless reproduction control data, does not perform decoding of the forward-referring type pictures.

2. The reproduction apparatus according to claim 1, further comprising a reference insertion unit for, if one or a plurality of consecutive forward-referring type pictures are present at a head of a reproduction section, inserting a reference picture that is to be referred to by the forward-referring type pictures after the seamless reproduction control data that is inserted before the reproduction section by the control data insertion unit.

3. The reproduction apparatus according to claim 2, further comprising a parallel decoding unit for decoding the reference picture in parallel with decoding of the preceding reproduction section.

4. The reproduction apparatus according to claim 1, further comprising an audio mute procedure unit for performing an audio mute procedure during a time period between (a) a predetermined time period before a connecting point of the reproduction sections and (b) a reproduction starting time of the reproduction section following the connecting point.

5. The reproduction apparatus according to claim 1, further comprising:
an audio fade-out unit for performing an audio fade-out procedure a predetermined time period before a connecting point of the reproduction sections; and
an audio fade-in unit for performing an audio fade-in procedure at a reproduction starting time of the reproduction section following the connecting point.

6. The reproduction apparatus according to claim 1, further comprising a reproduction starting point rounding unit for, if a time specified as a starting point of a reproduction section does not agree with a starting point of a reproduction fundamental unit, making a head of a reproduction fundamental unit following the reproduction fundamental unit including the point specified as the starting point of the reproduction section the reproduction starting point of the reproduction section, wherein the reproduction fundamental unit is a unit of multiplexing audio data and video data in the AV data stream.

7. The reproduction apparatus according to claim 1, further comprising a reproduction ending point rounding unit for, if a point specified as an ending point of a reproduction section does not agree with an ending point of a reproduction fundamental unit, making a termination of a reproduction fundamental unit preceding the reproduction fundamental unit including the point specified as the ending point of the reproduction section the reproduction ending point of the reproduction section, wherein the reproduction fundamental unit is a unit of multiplexing audio data and video data in the AV data stream.

8. The reproduction apparatus according to claim 1, further comprising an intrapicture-coded picture frame-advance reproduction unit for reproducing only a first intrapicture-coded picture in a reproduction fundamental unit, wherein the reproduction fundamental unit is a unit of multiplexing audio data and video data in the AV data stream.

9. The reproduction apparatus according to claim 1, further comprising a terminal picture frame-advance reproduction unit for reproducing only a picture at a termination in a reproduction fundamental unit, wherein the reproduction fundamental unit is a unit of multiplexing audio data and video data in the AV data stream.

10. The reproduction apparatus according to claim 1, wherein a coding standard for the AV data is the MPEG.

11. The reproduction apparatus according to claim 10, wherein the forward-referring type picture is a B picture.

12. The reproduction apparatus according to claim 10, wherein the control data insertion unit inserts a Sequence End Code prescribed by the MPEG standard as the seamless reproduction control data.

13. The reproduction apparatus according to claim 10, wherein the control data insertion unit inserts a control stream that is not present in the MPEG stream as the seamless reproduction control data.

14. The reproduction apparatus according to claim 13, wherein the control stream has a specific stream ID and also contains dummy data.

15. The reproduction apparatus according to claim 1, wherein the AV data is read from a DVD.

16. A reproduction method in which a coded AV data stream is decoded and the decoded AV data stream is reproduced, comprising the steps of:
in seamless reproduction to connect reproduction sections specified in the AV data stream in an arbitrary order, inserting seamless reproduction control data between the reproduction sections to be connected; and
when the seamless reproduction control data is detected in the AV data stream to be reproduced and if one or a plurality of consecutive forward-referring type pictures are present at a head of the reproduction section following the detected seamless reproduction control data, canceling decoding of the forward-referring type pictures.

17. The reproduction method according to claim 16, wherein if one or a plurality of consecutive forward-referring type pictures are present at a head of a reproduction section, a reference picture that is to be referred to by the forward-referring type pictures is inserted after the seamless reproduction control data that is inserted before the reproduction section, instead of the canceling of the decoding.

18. The reproduction method according to claim 16, further comprising a reproduction starting point rounding step of, if a time specified as a starting point of a reproduction section does not agree with a starting point of a reproduction fundamental unit, making a head of a reproduction fundamental unit following the reproduction fundamental unit including the point specified as the starting point of the reproduction section the reproduction starting point of the reproduction section, wherein the reproduction fundamental unit is a unit of multiplexing audio data and video data in the AV data stream.

19. The reproduction method according to claim 16, further comprising a reproduction ending point rounding step of, if a point specified as an ending point of a reproduction section does not agree with an ending point of a reproduction fundamental unit, making a termination of a reproduction fundamental unit preceding the reproduction fundamental unit including the point specified as the ending point of the reproduction section the reproduction ending point of the reproduction section, wherein the reproduction fundamental unit is a unit of multiplexing audio data and video data in the AV data stream.
